(19) United States
(12) Patent Application Publication
(10) Pub. No.: US 2014/0292619 A1
(43) Pub. Date: Oct. 2, 2014

(54) DISPLAY SYSTEM, DISPLAY CONTROL APPARATUS, AND IMAGE PROVISION APPARATUS THEREOF

(71) Applicant: KABUSHIKI KAISHA TOSHIBA, Tokyo (JP)

(72) Inventors: Tsuyoshi HIOKI, Yokohama-shi (JP); Yutaka NAKAI, Yokohama-shi (JP)

(21) Appl. No.: 14/304,167

(22) Filed: Jun. 13, 2014

Related U.S. Application Data
(63) Continuation of application No. 12/372,601, filed on Feb. 17, 2009.

(30) Foreign Application Priority Data
Mar. 27, 2008 (JP) 2008-084966

(51) Int. Cl. G06F 3/14

(52) U.S. Cl. CPC G06F 3/1446
USPC 345/1.3

(57) ABSTRACT

A display system is provided with a display apparatus including a plurality of display panels arranged in a line, and connected in series, and connectors to connect the display panels in series, an storage unit to store therein a plurality of area image data on a plurality of areas into which the image to be displayed on the display apparatus is divided, a detection unit to detect a number of connections of the display panels on the basis of a connection state of the connectors, a selection unit to select area image data corresponding to the number from the storage unit, and an output unit to output the selected area image data to the display panels.

### CROSS-REFERENCE TO RELATED APPLICATIONS

This application is a continuation of U.S. Application Ser. No. 12/372,601, filed Feb. 17, 2009, which is based upon and claims the benefit of priority from prior Japanese Patent Application No. 2008-084966, filed Mar. 27, 2008, the entire contents of both of which are incorporated herein by reference.

### BACKGROUND OF THE INVENTION

1. Field of the Invention

The present invention relates to a display system for displaying an image on a plurality of display panels, a display control apparatus, and an image provision apparatus thereof.

2. Description of the Related Art

In a display apparatus which realizes a large-sized screen widely used at present, a flat panel display (FPD) such as a liquid crystal display (LCD), a plasma display panel (PDP), and the like formed in a desired screen size, a rear projection, an LED display in which light-emitting diodes are arranged in each pixel, and the like are used. These are manufactured in the manufacturing step in accordance with a prescribed screen size such as a diagonal dimension of 50 or 100 inches.

Conversely, an information display apparatus in which display panels manufactured in a standardized screen size are used, and the plural display panels are arranged like tiles to be integrated with each other in accordance with the installation circumstance is now examined. In, for example, JP-A No. 2001-166159 (KOKAI), each of display panels is provided with an ID assigned thereto in advance, and a control apparatus individually transmits an image signal to be transmitted to each display panel in accordance with the ID. For example, a control apparatus such as a personal computer or the like is used to divide an image signal to be displayed on the display panels, thereby realizing a set of continuous installation circumstance. Accordingly, the system is such that the image source which is the genesis is divided and displayed on the basis of the definition standardized and prescribed in advance like video graphics array (VGA: 640×480), extended graphics array (XGA: 1024×768), high definition<HD: 1920×1080), and the like.

However, in the display system described above, the definition and the display area cannot be freely determined in accordance with the installation circumstance of the display apparatus without being limited to the image distribution based on the definition standard determined in advance. That is, although the display panel itself is limited to the standardized definition and screen size, by arranging the display panels in a tiling manner, a screen size and definition with a higher degree of freedom can be realized. However, the display system, the transmission system, and the storage system are limited to the standardized definition, and hence there is a problem that it is difficult to make the best use of the degree of freedom of the display apparatus.

Further, in the existing image transmission and storage means, for example, the definition is based on the standardized format such as that of Hi-Vision, i.e., 1920×1080×RGB, and the aspect ratio of 16:9. Thus, as for a display apparatus which is not conforming to the standard, there is no alternative but to display an image by enlarging or reducing the image in accordance with the standard. Further, as for the future image transmission system surpassing the Hi-Vision, systems such as the cinema standard and super Hi-Vision, are proposed. However, as for these systems, although image transmission improved in the definition will be enabled, as for the arbitrariness of these systems, only definition information within a predetermined area of definition can foe realized on the display apparatus.

Further, for example, in a case of image transmission using the Internet, distribution of the entire standardized image resources becomes necessary. Accordingly, the image transmission is performed in a state where image resources unnecessary in the installation circumstance are also included in the image resources, and hence image transmission is performed in a state where unnecessary traffic is included in the transmission. Thus, the traffic for the transmission of the unnecessary image data becomes enormous, and the communication infrastructure is excessively loaded.

As described above, in the display system of the ordinary tiling system, it is necessary to set in advance the ID, the position information, and the like of each display panel in the control apparatus, and hence much labor is required when the extension or the like of the display area is performed. Further, image data of the entire image is transmitted regardless of the display area, and hence there is a problem that the network is excessively loaded.

### BRIEF SUMMARY OF THE INVENTION

According to an aspect of the present invention, there is provided a display system including: a display apparatus including a plurality of display panels arranged in a line, and connectors to connect the display panels in series; a storage unit to store therein a plurality of area image data on a plurality of areas into which an image to be displayed on the display apparatus is divided; a detection unit to detect a number of connections of the display panels on the basis of a connection state of the connectors; a selection unit to select area image data corresponding to the number from the storage unit; and an output unit to output the selected area image data to the display panels.

According to another aspect of the present invention, there is provided a display control apparatus to cause a display apparatus including a plurality of display panels arranged in a line, and connectors to connect the display panels in series to display an image, including: a detection unit to detect a number of connections of the display panels on the basis of a connection state of the connectors; an input unit to input area image data corresponding to the number from among a plurality of area image data on a plurality of areas into which the image is divided; and an output unit to output the area image data to the display panels.

According to another aspect of the present invention, there is provided an image information provision apparatus to provide an image to be displayed on a display apparatus including a plurality of display panels arranged in a line, and connectors to connect the display panels in series to the display apparatus, including: a storage unit to store therein a plurality of area image data on a plurality of areas into which the image to be displayed on the display apparatus is divided; and a selection unit to select area image data corresponding to a number of connections of the display panels from the storage unit in accordance with the number as the image to foe provided to the display apparatus.

### BRIEF DESCRIPTION OF THE SEVERAL VIEWS OF THE DRAWING

FIG. 1 is a functional block diagram showing an embodiment of a display system according to the present invention.

FIG. 2 is a view showing an example of the arrangement of display panels.

FIG. 3 is a view showing an example of the device configuration of a display apparatus.

FIG. 4 is a flowchart showing an operation of a display system.

FIG. 5 is a view showing an example of image content.

FIG. 6 is a view showing an example of area division of the image content shown in FIG. 5.

FIG. 7 is a view showing a display example of a case where the number of display panels n is 1 (n=1).

FIG. 8 is a view showing a display example of a case where the number of display panels n is 3 (n=3).

FIG. 9 is a schematic view showing the system configuration of Example 1.

FIG. 10 is a view showing an example of a realizable installation circumstance in Example 1.

FIG. 11 is a view showing another example of a realizable installation circumstance in Example 1.

FIG. 12 is a view showing still another example of a realizable installation circumstance in Example 1.

FIG. 13 is a schematic view showing the system configuration of Example 2.

FIG. 14 is a schematic view showing the system configuration of Example 3.

FIG. 15 is a schematic view showing another example of the system, configuration of Example 3.

### DETAILED DESCRIPTION OF THE INVENTION

An embodiment of the present invention will be described below in detail with reference to the accompanying drawings.

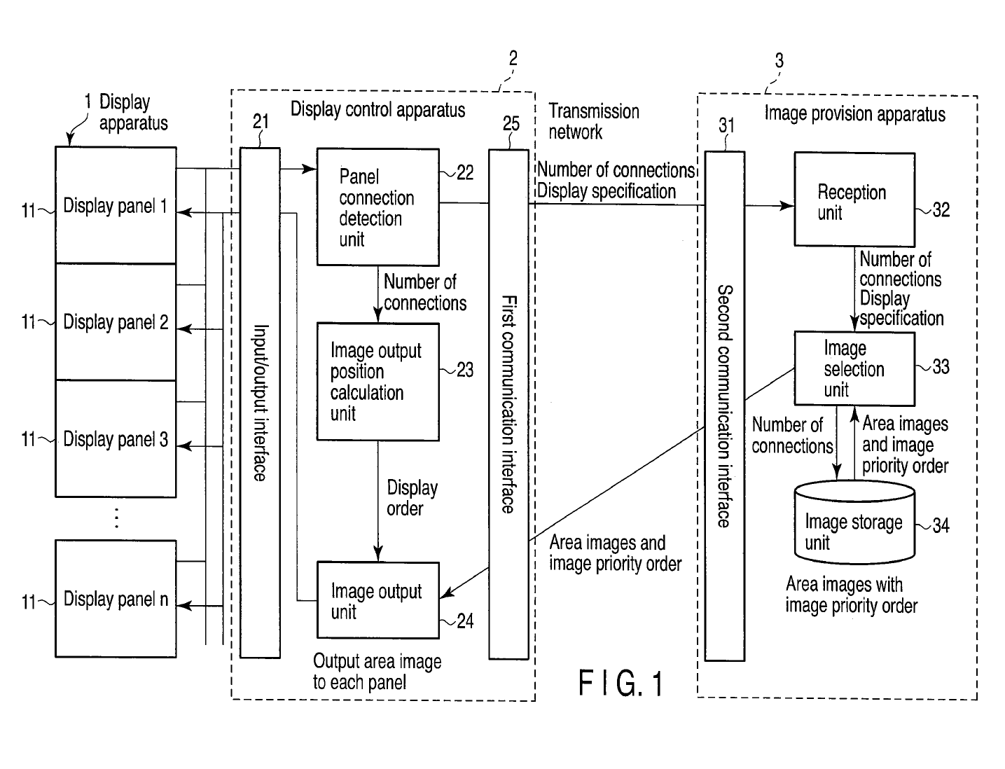

FIG. 1 is a functional block diagram showing an embodiment of a display system according to the present invention.

This system includes a display apparatus 1 provided with a plurality of display panels 11, a display control apparatus 2, and an image provision apparatus 3. The display control apparatus 2 and the image provision apparatus 3 are connected to each other through a transmission network such as the Internet, and the display control apparatus 2 causes the display apparatus 1 to display an image provided from the image provision apparatus 3.

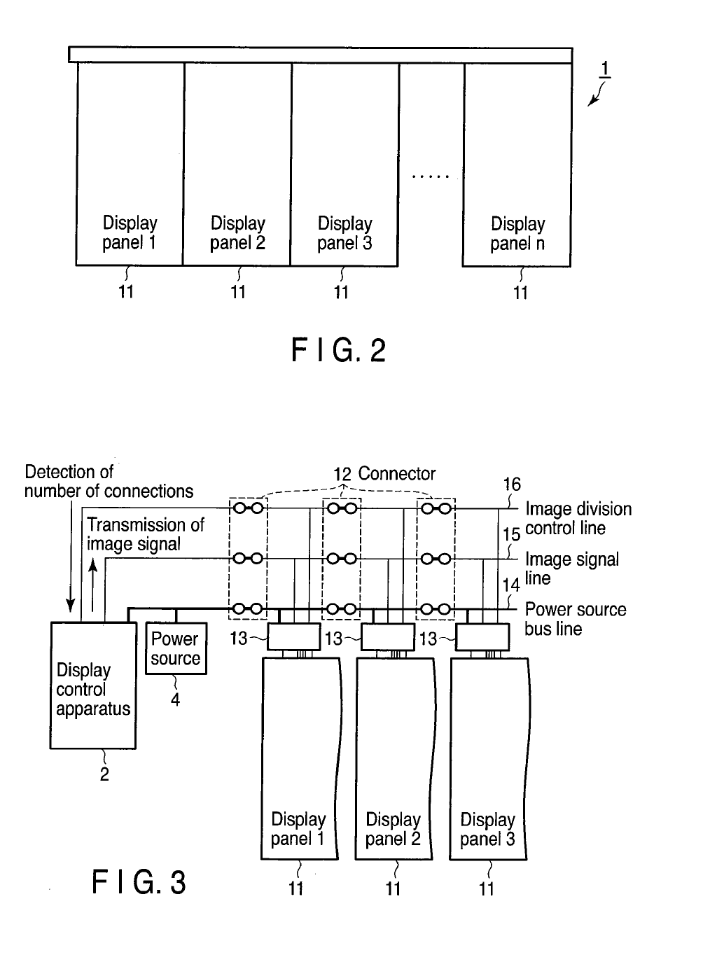

The display apparatus 1 is constituted of, for example, a plurality of display panels 11 arranged in a line, and having the same screen size as shown in FIG. 2. FIG. 3 shows an example of the device configuration of the display apparatus 1. Each display panel 11 is provided with a connector 12 for connecting the display panel 11 in series, and a panel operation processor 13. The display panels 11 are connected to each other through the connectors 12. Further, each of a power source bus line 14, an image signal line 15, and an image division control line 16 is connected to the display panels 11 through the connectors 12.

Drive power is supplied from a power source 4 to each display panel 11 through the power source bus line 14. An image signal output from the display control apparatus 2 is input to each display panel 11 through the image signal line 15, and image display processing is performed by the panel operation processor 13. The image division control line 16 is provided to detect the number of connections of the display panels 11. For example, by adding passive elements such as a resistor to be connected in series to the connector 12 of the image division control line 16 or a capacitance (capacitor) to be connected in parallel to the connector 12, and by detecting the overall resistance or the overall capacitance, the overall number of connections can be detected. Further, a digital circuit that can be counted/detected may be incorporated in the connector 12. Accordingly, even when display panels 11 of an arbitrary number are connected by the user, the number of connections can be detected without performing any particular setting.

The display control apparatus 2 includes an input/output interface 21, a panel connection detection unit 22, an image output position, calculation unit 23, an image output unit 24, and a first communication interface 25. The input/output interface 21 is an interface of the image input/output standardization represented by, for example, the digital visual interface (DVI) and the like, and is used to perform input/output of an image signal between the display apparatus 1 and the display control apparatus 2. The first communication interface 25 is used to perform communication between the image provision apparatus 3 and the display control apparatus 2 through the transmission network.

Here, the panel connection detection unit 22 has a function of detecting the number of connections of the display panels 11 by means of the image division control line 16. The image output position calculation unit 23 calculates the output position of the image in accordance with the number of connections of the display panels 11. The image output unit 24 outputs image data obtained from the image provision apparatus 3 to each display panel 11 in accordance with the calculated output position, i.e., in accordance with the connection position of the display panel.

The image provision apparatus 3 includes a second communication interface 31, a Reception unit 32, an image selection unit 33, and an image storage unit 34. The second communication interface 31 is used to perform communication between the display control apparatus 2 and the image provision apparatus 3 through the transmission network. The Reception unit 32 receives the number of connections and display specifications (resolution, number of pixels, and the like) necessary for image display such as image standard transmitted from the display control apparatus 2 through the second communication interface 31. In the image storage unit 34, data on a plurality of area images formed by dividing, for example, an overall image to be displayed by the display apparatus 1 into a plurality of areas in accordance with the display specifications of the display panels 11 is stored. The area image data is shot by a video camera, or produced by computer graphics (CG) in advance. Further, an image priority order is added in advance to each of the area image data by, for example, the cameraman or the CG creator, and is stored correspondently to each of the area image data. The image selection unit 33 selects the area image data corresponding to the received number of connections from the image storage unit 34, and transmits the selected area image data to the display control apparatus 2 by means of the second communication interface 31 through the transmission network.

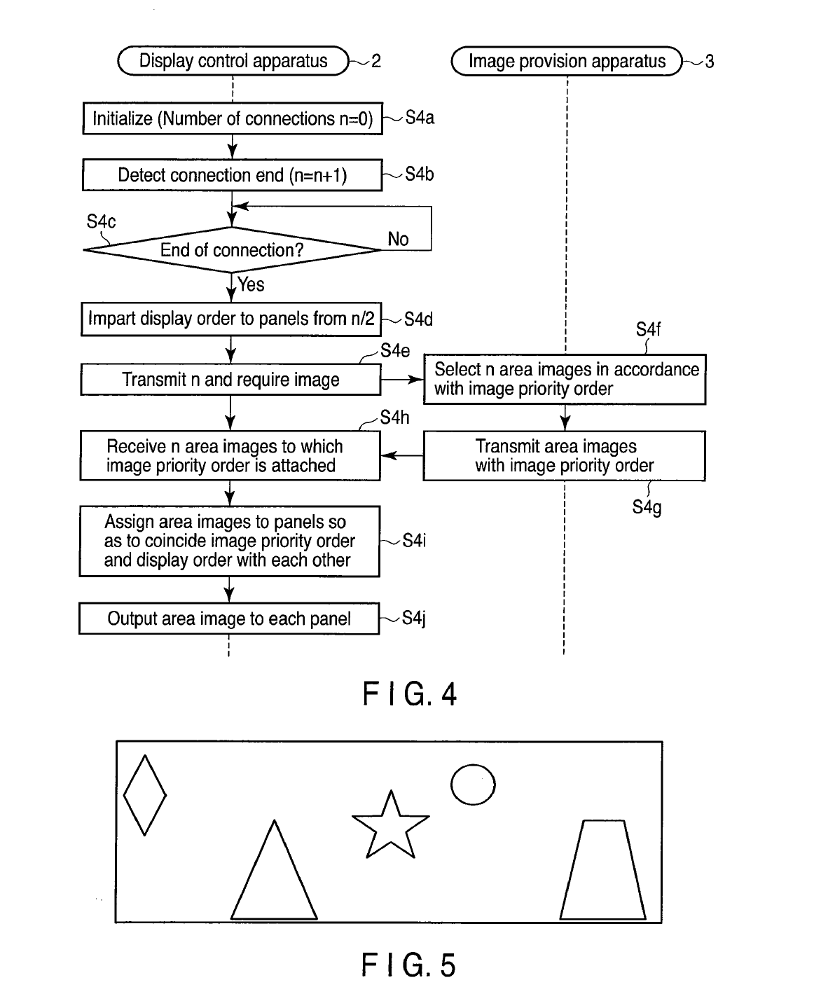

Next, an operation of the display system configured as described above will be described below. FIG. 4 is a flowchart showing the procedures and the contents of the operations of the display control apparatus 2 and the image provision apparatus 3.

When the power is turned on, the display control apparatus 2 performs initialization processing to initialize “n” to zero (step S4a). “n” stands for the number of the connections of the display panels 11. The panel connection detection unit 22 performs detection of “n”. As described above, resistors and capacitors are added to the connectors of the image division control line 16, and the panel connection detection unit 22 detects the connection end on the basis of the resistance or the capacitance of the image division control line 16 (step S4b). The panel connection detection unit 22 can obtain “n” by performing the above detection processing up to the connection end, and detecting the overall resistance or the overall capacitance (step S4c: YES). By operating as described above, it becomes possible to detect the overall display device number without performing setting of the ID or connection position for each display panel 11. Accordingly, even when the user arranges display panels of an arbitrary number in a line, it becomes possible to detect “n” of the display panels 11 without setting particularly.

Then, the image output position calculation unit 23 imparts the display order to each display panel 11 on the basis of the detected “n” (step S4d). At this time, the display panel 11 arranged at the n/2th (the number of decimal places is rounded up) position occupies the central position of the display panel 11 group arranged in a line. Thus, the central position can be set at n/2, and the image output position calculation unit 23 sets the n/2th display panel at 1, setting the display panels in the order of adjacency to the n/2th display panel alternately on the right and left at 2, 3, 4, . . . to set the display order. When “n” is an odd number, for example, 5 (n=5), n/2 becomes 2.5 (n/2=2.5), and hence the third panel is set at the central position. Further, when “n” is an even number, for example, 4 (n=4), n/2 becomes 2 (n/2=2), and the second panel is set at the central position. The display control apparatus 2 transmits information indicating “n” detected by the panel connection detection unit 22 and the display specifications to the image provision apparatus 3, and requires the image provision apparatus 3 to provide image data thereto (step S4e).

On the other hand, when the information indicating “n” and the display specifications are received in the image provision apparatus 3, the image selection unit 33 selects area image data corresponding to “n” from the image storage unit 34 in accordance with the received information (step S4f). At this time, the image selection unit 33 selects the area image data in sequence from that higher in the image priority order attached to the area image data. In the image storage unit 34, it is possible to refer to image areas, “m” standing for the number of the areas, and the image priority order set in advance by the video cameraman or the CG creator. In general, the video cameraman or the CG creator arranges the most important substance or contents in the center of the image in many cases. For example, in a scene of a mountain, the arrangement is such that ridge lines extend in the right and left directions with the summit of the mountain being in the center. Accordingly, in this embodiment, it is set in each image area, that the image priority order be put symmetrically from the center. Here, the symmetrical order may be from the left to right or from the right to left. Further, information indicating the left to right or the right to left may be included in the image priority order, or may be provided separately. Further, the left to right or the right to left information can be standardized in advance. Further, when “m” is larger than “n” (m>n), the image selection unit 33 extracts n area image data in accordance with the image priority order set in advance, and transmits the n area image data from the second communication interface 31 to the display control apparatus 2 together with the information indicating the image priority order (step S4g).

The display control apparatus 2 receives the n area image data to which the image priority order is attached, and which are transmitted from the image provision apparatus 3 by the first communication interface 25 (step S4h). Further, the display control apparatus 2 assigns the area image data to the respective display panels 11 in such a manner that the display order set in step S4d. and the image priority order coincide with each other (step S4i). That is, the area image data having the highest image priority order is assigned to the display panel 11 corresponding to the set central position. The image output unit 24 transmits the respective area image data together with the imparted display order, whereby desired image data is transmitted to each display panel 11 (step 34j).

Therefore, with this display system, it becomes possible to display image data desired by the image creator or the image distributor at the central position in a circumstance in which an arbitrary number of display panels are set without requiring any particular setting.

FIGS. 5 to 8 schematically show display examples of image data obtained by the above processing. FIG. 5 shows the overall image data. In a display system of the ordinary tiling system, the overall image data as shown in FIG. 5 is distributed to the transmission network irrespectively of the display area, operation processing is performed on the basis of the definition information and the aspect ratio information of the display apparatus, whereby a part of the image data is output, or the image data is output after being subjected to enlargement or reduction. Accordingly, the display may be different from that intended by the image creator or the image distributor in some cases.

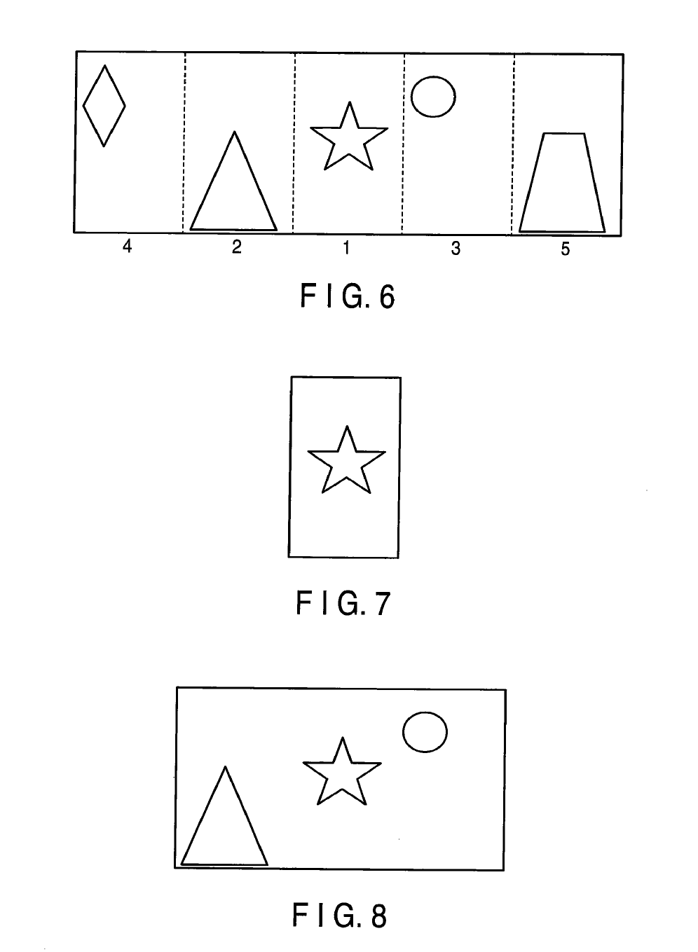

On the other band, in the present invention, the overall image is divided into a plurality of area images in accordance with the display specifications of the display panels. For example, FIG. 6 shows a state where the overall image shown in FIG. 5 is divided into five areas by the broken lines. That is, the broken lines in FIG. 6 indicate boundaries between the plural area images. In FIG. 6, a numeral attached to each of the area images is the image priority order, and it is assumed that “1” indicates the area image of the top priority. As described above, the image data is divided in advance into areas, and each area is provided with the image priority order, and hence it becomes possible to preferentially display a desired area. Accordingly, in the case where the display system sets one area in FIG. 6 (for example, a case where the display system includes only one display panel 11, or the like), an image shown in FIG. 7 can be displayed, and in the case where the display system sets three areas (for example, a case where the display system include three display panels 11), an image shown in FIG. 8 can be displayed.

Specific application examples of the display system according to this embodiment will be described below in accordance with each example. Incidentally, the same parts as those of FIG. 1 are denoted by the same reference symbols, and detailed description of them will be omitted.

### EXAMPLE 1

In Example 1, an image acquired from an image server on the Internet such as a wide-area network is displayed on a display apparatus constituted of a plurality of display panels.

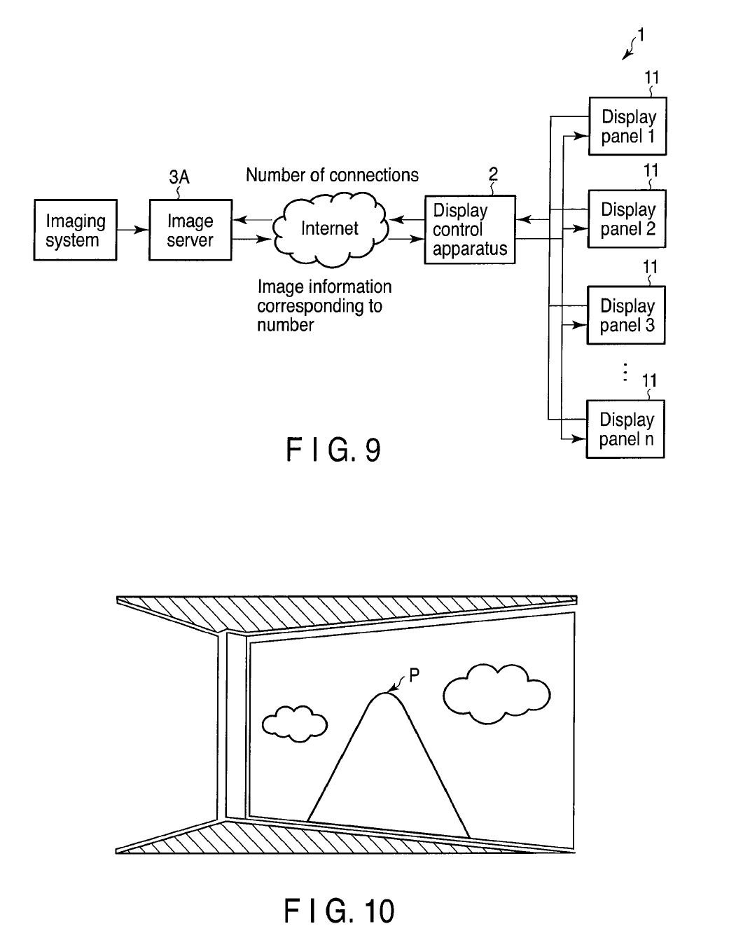

FIG. 9 is a schematic view showing the system configuration in Example 1. In FIG. 9, an image provision apparatus 3 is configured as an image server 3A arranged on the Internet. The image server 3A is connected to a display control apparatus 2 through the Internet, and transmits an image generated by an imaging system to the display control apparatus 2. At present, in the information transmission performed through the Internet, a greater amount of information can be transmitted by the development of the optical communication network. Accordingly, in an optical communication network directly connected to the trunk network, it is now becoming possible to transmit more than a plurality of image data of, for example, the Hi-Vision. Further, as for the integrated circuit for processing the image, it is possible to simultaneously process more than a plurality of image data.

After the power is turned on, the display control apparatus 2 detects the number of connections of the display panels 11 on the basis of the connection state of the connectors of the image division control line 16, transmits the number to the image server 3A, and requires the image server 31 to provide image data thereto. In the image server 3A, a plurality of area image data formed by dividing an image to be shot into a plurality of areas by the cameraman, or the like are stored together with the image priority order. In response to this requirement, the image server 3A selects area image data corresponding to the number from the plural area image data in accordance with the image priority order, and transmits the selected area image data to the display control apparatus 2. The display control apparatus 2 receives the transmitted area image data through the Internet, and outputs the received area image data to the display panels 11 in accordance with the display order given on the basis of the number. It should be noted that the image priority order is added to the area image data, and hence the area image data is output to the display panel 11 in such a manner that the image priority order and the display order coincide with each other.

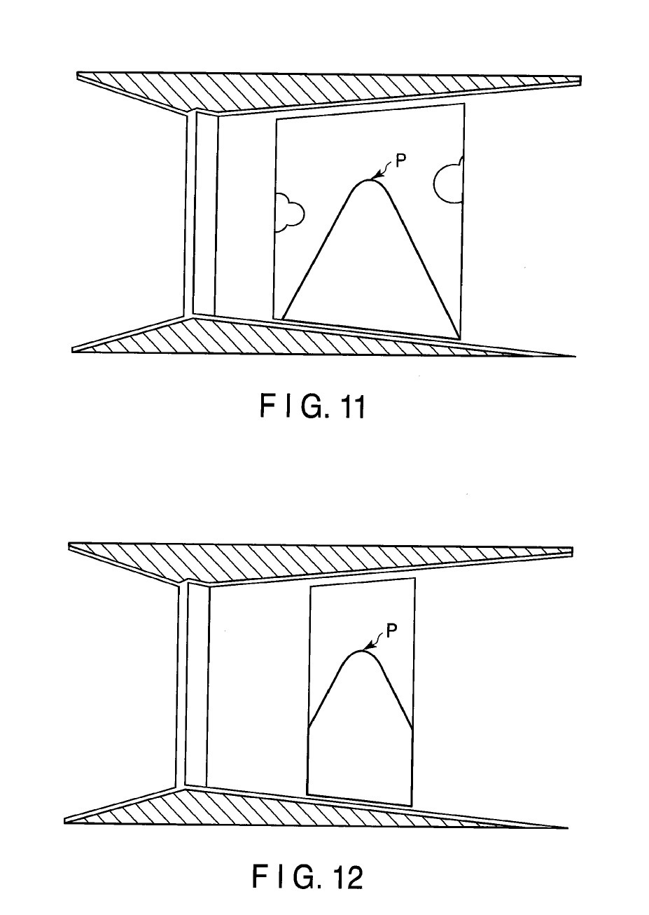

Schematic examples of the installation circumstance enabled by the above-mentioned display system are shown in FIGS. 10 to 12. In this system, different image circumstances can be set depending on the installation state of the display apparatus. When the installation number of the display panels is large, the installation circumstance shown in FIG. 10 can be set. Conversely, as the number of the display panels becomes smaller, the installation circumstance becomes as shown in FIGS. 11 and 12. However, in this embodiment, as for the area (corresponding to the summit P in FIGS. 10 to 12) to be in the center intended by the content creator, the area can be displayed in any installation circumstance. Further, in this embodiment, the number of display panels is automatically detected, and hence when the display panel is connected, the display area can be extended without performing any particular setting. For example, at the time of introduction, the fundamental system shown in FIG. 12 is introduced, and the number of the display panels is increased in accordance with the intention of the installer, whereby it is also possible to construct the installation circumstance shown in FIG. 10.

### EXAMPLE 2

In Example 2, channel numbers of satellite broadcasting are assigned to separated images for a plurality of display panels to be displayed.

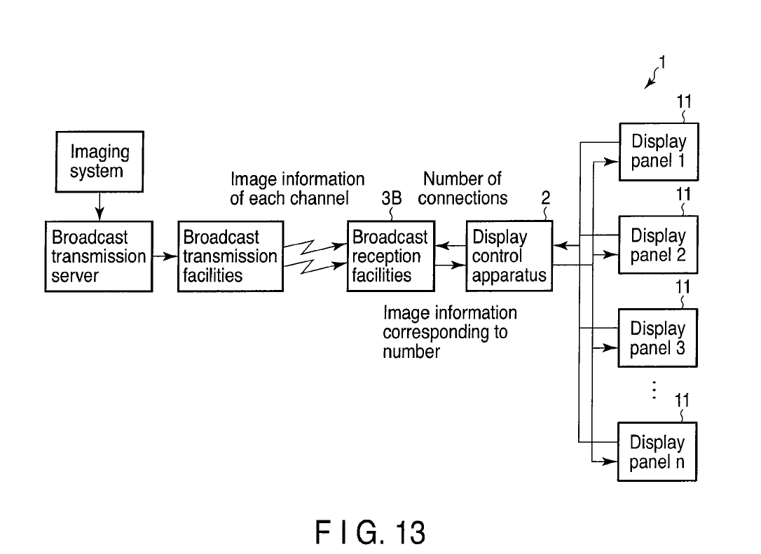

FIG. 13 is a schematic view showing the system configuration of Example 2. In FIG. 13, this system is provided with a broadcasting network for transmitting an image, and an image provision apparatus 3 is configured as broadcast reception facilities 3B. A display control apparatus 2 transmits the number of connections of the display panels 11 to the broadcast reception facilities 3B, and requires the facilities 3B to provide image data thereto. In response to this requirement, the broadcast reception facilities 3B receive images of the number of channels corresponding to the number of the connections of the display panels 11, and transmit the received images to the display control apparatus 2.

In current broadcasting networks, both terrestrial broadcasts and satellite broadcasts have advanced in terms of digital operation, and hence it is possible to distribute a remarkably larger amount of image data as compared with conventional analog broadcasts. For example, in a digital broadcast, it is possible to assign channel numbers of three digits, and hence it is also possible to set the upper two digits as the fundamental number, and assign image-divided image data to the lower one digit. For example, it is possible to assign image-divided image signals to channel numbers from 551 to 559, and simultaneously distribute image data separated into nine areas from the channel number from 551 to 559 in accordance with the priority order. Accordingly, it becomes possible, in a installation circumstance in which, for example, three display panels 11 are installed as a display apparatus, to transmit and display image data of the channel numbers 551 to 553 in the order of 552, 551, and 553 in accordance with the installation state of the display apparatus.

After the power is turned on, the display control apparatus 2 detects the number of connections of the display panels 11 according to the connection state of the connectors of the image division control line 16, transmits the number to the broadcast reception facilities 3B, and requires the facilities 3B to provide image data thereto. Open, receipt of the number by the requirement, the broadcast reception facilities 3B set receiving channels corresponding to the number. For example, in the case of nine channels numbered from 551 to 559, the broadcast reception facilities 3B receive image signals of five channels of the channel numbers 551, 552, 553, 554, and 555 in accordance with predetermined image priority order, when it is detected that the number of connections of the display panels 11 is five. The broadcast reception facilities 3B add the lower one digit information of the channel number which is priority order information to the image data of the received image signal as the image priority order, and thereafter transmit the resultant image signal to the display control apparatus 2. As a result of this, it is possible to refer to the image areas, the number of the areas, and the image priority order set in advance by the broadcast enterpriser. The display control apparatus 2 receives the received image data, and outputs the received image data to the display panels 11 in accordance with the display order given on the basis of the number, and in the image priority order.

When Example 2 described above is used too, it is possible to realize the installation circumstances as shown in Example 1, and as shown in, for example, FIGS. 10 to 12 as the effect thereof, and as for the expandability thereof too, it is possible to construct the similar installation circumstances.

### EXAMPLE 3

In Example 3, images recorded on an image recording medium are assigned to a plurality of display panels to be displayed.

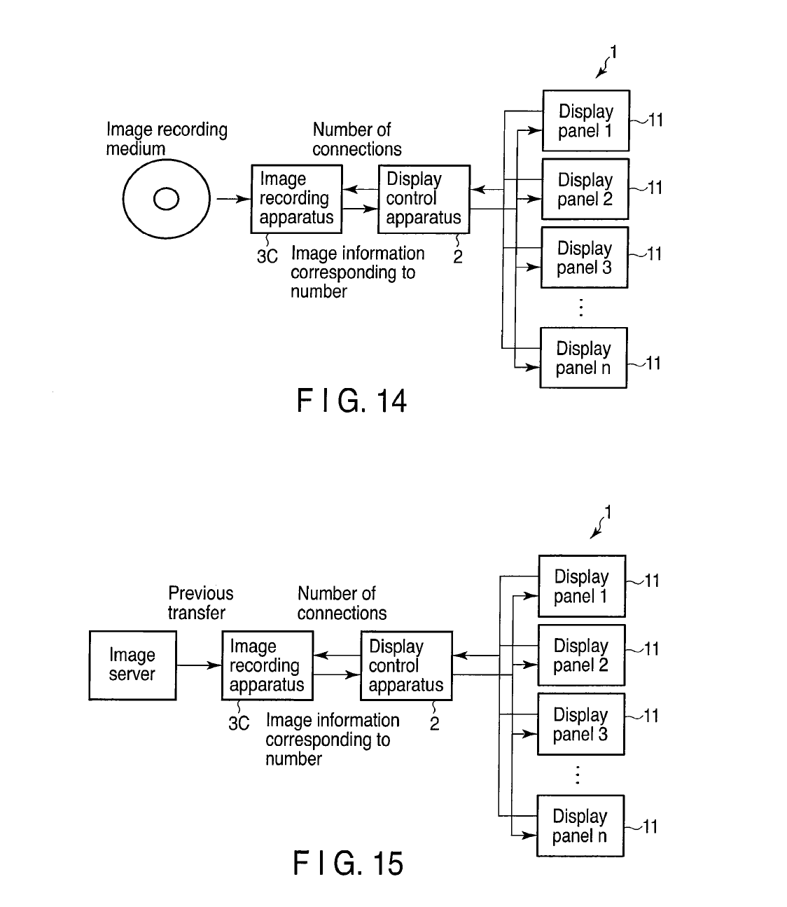

FIG. 14 is a schematic view showing the system configuration of Example 3. An image provision apparatus 3 is constituted of an image recording apparatus 3C into which an image recording medium can be inserted. As the image recording medium, a Digital Versatile Disk (DVD), a hard disk, and an 3D memory card, are widely used, for temporary storage media.

Even when these recording media are utilized, it is possible to impart image priority order to each of a plurality of data on area images formed by dividing the overall image into a plurality of areas, and record the resultant data. In the case of this system, a display control apparatus 2 is directly connected to the image recording apparatus 3C. Accordingly, the area to which the number of connections of display panels 11 is transmitted by means of the interactive communication is limited to the inside of the installation circumstance as in the case of Example 1.

In the configuration described above, after the power is turned on, the display control apparatus 2 detects a number of connections of the display panels 11 on the basis of the connection state of the connectors of an image division control line 16, transmits the number to the image recording apparatus 3C, and requires the image recording apparatus 3C to provide image data thereto. Upon receipt of the number by this requirement, the image recording apparatus 3C selects area image data corresponding to the number from an image recording medium in accordance with the image priority order, and provides the selected area image data to the display control apparatus 2. The display control apparatus 2 receives the area image data provided from the image recording apparatus 3C, and outputs the received area image data to the display panels 11 in sequence from the area image data having the higher image priority order in accordance with the display order given on the basis of the number.

When Example 3 described above is used too, it is possible to realize the installation circumstances as shown in Example 1, and as shown in, for example, FIGS. 10 to 12 as the effect thereof, and as for the expandability thereof too, it is possible to construct similar installation circumstances.

Further, as an application of Example 3, it is possible to construct a home server system. For example, as shown in FIG. 15, it is also possible to acquire images from an image server in accordance with the transmission amount and the transmission rate of the image signal, previously store image data in a temporary recording medium of a higher speed, and transmit the image data from the image recording apparatus 3C to a display apparatus 1 by the control of the display control apparatus 2.

As described above, in the above-mentioned embodiment, the number of display areas can be changed in accordance with the detected number of connections of the display panels, the order for displaying image is given on the basis of the number, and the images are output to the display panels in sequence firstly from the display panel positioned at the center. Further, by adding image priority order to the area image data, it is possible to preferentially display a desired image even when the number of display panels is smaller than the total number of area image data.

Therefore, according to the embodiment described above, it becomes possible to realize a display system in which display areas can be arbitrarily extended irrespectively of the image standard. Further, the number of the display panels is detected on the basis of the connection state of the connectors, and hence it is not necessary to perform particular setting of the ID or position information on the display panels, and it becomes possible to easily extend the display areas. Further, in the image transmission from the image provision apparatus 3 to the display control apparatus 2, only image data corresponding to the number of the display panels is transmitted, and hence it is possible to reduce redundant traffic in the transmission.

It should be noted that the present invention is not limited to the above-mentioned embodiment as it is. For example, although in the embodiment described above, in order to detect the number of the connections of the display panels, the image division control line 16 is separately provided, the power source bus line 14 can also be used as the image division line 14. It is possible, as in the case where the image division control line 16 is used, to realize the detection of the number of the connections of the display panels by adding resistors or capacitors to the connectors of the power source bus line 14.

Further, in the embodiment described above, the display system is configured in such a manner that the display order is imparted in sequence to the display panels firstly from the display panel in the central position by the image output position calculation unit 23 on the basis of the number of connections of the display panels. However, the configuration is not limited to this, the display order may be imparted to the display panels in sequence from the left side or from the right side, and the manner in which the display order is imparted to the display panels can be arbitrarily set by the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of controlling a display apparatus including a plurality of display panels connected in series to one another, comprising:
detecting, via a panel connection detection unit, a number of connections on the basis of a resistance or a capacitance of an image division control line connecting the plurality of display panels to one another; and
imparting, via an image output position calculation unit, a display order to each display panel in the plurality of display panels on the basis of a number of panels (n) corresponding to the number of connections.

2. The method of claim 1, wherein the step of imparting the display order comprises:
setting a display central panel as the panel arranged at a position equal to the number of panels (n) divided by two rounded up to a next decimal; and
setting the display panels in the order of adjacency to the central display panel alternately on the right and left to set the display order.

3. The method of claim 1, further comprising:
transmitting the number of panels (n) and the display order to an image provision apparatus; and
selecting area image data corresponding to the number of panels (n) from an image storage unit in accordance with the display order.

4. The method of claim 3, further comprising:
selecting the area image data in sequence from a higher image priority order attached to the area image data to lower image priority order with the higher image priority order.

5. The method of claim 4, further comprising:
assigning the area image data to the plurality of display panels in such a manner that the display order and the image priority order coincide with each other.

6. The method of claim 4, further comprising:
assigning the area image data to the plurality of display panels in such a manner that the higher image priority data corresponds to the central display panel.

7. The method of claim 1, further comprising:
performing, when power is turned on to the display apparatus, at initialization process to initialize the number of connections corresponding to the number of panels (n) in the plurality of display panels.

8. A method of controlling a display apparatus including a plurality of display panels connected in series to one another, comprising:
detecting an overall resistance or an overall capacitance of an image division control line connecting the plurality of display panels when power is turned to the display apparatus;
determining, based on the overall resistance or the overall capacitance, a display number for each display panel of the plurality of display panels; and
imparting a display order to each display panel based on the display number.

9. The method of claim 8, wherein the step of imparting the display order comprises:
corresponding the overall resistance or the overall capacitance of the image division control line to a number of connections, with the number of connections corresponding to a number of panels (n) in the plurality of display panels;
setting a display central panel as the panel arranged at a position equal to the number of panels (n) divided by two rounded up to a next decimal; and
setting the display panels in the order of adjacency to the central display panel alternately on the right and left to set the display order.

10. The method of claim 8, further comprising:
transmitting the number of panels (n) and the display order to an image provision apparatus; and
selecting area image data corresponding to the number of panels (n) from an image storage unit in accordance with the display order.

11. The method of claim 10, further comprising:
selecting the area image data in sequence from a higher image priority order attached to the area image data to lower image priority order with the higher image priority order.

12. The method of claim 11, further comprising:
assigning the area image data to the plurality of display panels in such a manner that the display order and the image priority order coincide with each other.

13. The method of claim 11, further comprising:
assigning the area image data to the plurality of display panels in such a manner that the higher image priority data corresponds to the central display panel.
